(19) United States
(12) Patent Application Publication
(10) Pub. No.: US 2008/0059672 A1
(43) Pub. Date: Mar. 6, 2008

(54) Methods and Apparatus for Scheduling Prioritized Commands on a Bus

(76) Inventors: John D. Irish, Rochester, MN (US); Chad B. McBride, Rochester, MN (US); David A. Norgaard, Rochester, MN (US); Dorothy M. Thelen, Rochester, MN (US)

Correspondence Address: IBM Corporation;Intellectual Property Law Dept. 917, 3605 Hwy. 52 North, Rochester, MN, 55901, US

(21) Appl. No.: 11/468,377

(22) Filed: Aug. 30, 2006

(51) Int. Cl. G06F 13/36

(52) U.S. Cl. 710/116

(57) ABSTRACT

In a first aspect, a first method of scheduling a command to be issued on a bus is provided. The first method includes the steps of (1) associating an address and priority with each of a plurality of commands to be issued on the bus, wherein the priority associated with each command is based on the address associated with the command; (2) updating the priority associated with each command after a predetermined time period; and (3) from the plurality of commands, selecting a command to be issued on the bus based on the address and updated priority associated with the command to be issued. Numerous other aspects are provided.

### FIELD OF THE INVENTION

The present invention relates generally to processors, and more particularly to methods and apparatus for scheduling prioritized commands on a bus.

### BACKGROUND

In a conventional system, a first processor may receive commands, which are to be placed on a bus, from a second processor. The first processor may split the received commands into a read command stream and a write command stream, store read commands in a read queue and store write commands in a write queue.

A conventional system may maintain order between the command streams by determining whether a read command at the top of the read queue depends on completion of a pending write command and/or whether a write command at the top the write queue depends on completion of a pending read command. More specifically, the conventional system employs a read address collision list to track addresses associated with pending read commands and a write address collision list to track addresses associated with pending write commands.

The conventional system may maintain a first dependency matrix indicating dependence of read commands on write commands. The first dependency matrix may be populated by data output from the write address collision list when indexed by respective read commands. Similarly, the conventional system may maintain a second dependency matrix indicating dependence of write commands on read commands. The second dependency matrix may be populated by data output from the read address collision list when indexed by respective write commands.

The conventional system may employ the dependency matrices and address collision lists to determine whether a command at the top of the read queue depends on a write command and/or whether a command at the top of the write queue depends on a read command and to issue commands therefrom. However, such a method of issuing commands on the bus, which is based solely on address collision dependencies, may not be tailored to system needs. Accordingly, improved methods and apparatus for issuing a command on a bus are desired.

### SUMMARY OF THE INVENTION

In a first aspect of the invention, a first method of scheduling a command to be issued on a bus is provided. The first method includes the steps of (1) associating an address and priority with each of a plurality of commands to be issued on the bus, wherein the priority is based on the address associated with the command; (2) updating the priority associated with the command after a predetermined time period; and (3) from the plurality of commands, selecting the command to be issued on the bus based on the associated address and updated priority.

In a second aspect of the invention, a first apparatus for scheduling a command to be issued on a bus is provided. The first apparatus includes (1) a bus; and (2) command issuing logic coupled to the bus and adapted to (a) associate an address and priority with each of a plurality of commands to be issued on the bus, wherein the priority associated with each command is based on the address associated with the command; (b) update the priority associated with each command after a predetermined time period; and (c) from the plurality of commands, select a command to be issued on the bus based on the address and updated priority associated with the command to be issued.

In a third aspect of the invention, a first system for scheduling a command to be issued on a bus is provided. The first system includes (1) a first processor; and (2) a second processor coupled to the first processor and adapted to receive a plurality of commands from the first processor. The second processor includes an apparatus for issuing a command on a bus, having (a) a bus; and (b) command issuing logic coupled to the bus and adapted to (i) associate an address and priority with each of the plurality of commands to be issued on the bus, wherein the priority associated with each command is based on the address associated with the command; (ii) update the priority associated with each command after a predetermined time period; and (iii) from the plurality of commands, select a command to be issued on the bus based on the address and updated priority associated with the command to be issued. Numerous other aspects are provided, as are systems and apparatuses in accordance with these other aspects of the invention.

Other features and aspects of the present invention will become more fully apparent from the following detailed description, the appended claims and the accompanying drawings.

### BRIEF DESCRIPTION OF THE FIGURES

FIGS. 1A-B is a block diagram of a system for scheduling a command to be issued on a bus based on address collision dependencies and a priority of the command in accordance with an embodiment of the present invention.

FIG. 2 illustrates an exemplary dependency matrix of the system of FIGS. 1A-B in accordance with an embodiment of the present invention.

FIG. 3 illustrates dependency matrices of the system of FIGS. 1A-B and signals employed thereby in accordance with an embodiment of the present invention.

FIG. 4 illustrates details of command issuing logic included in the system of FIGS. 1A-B in accordance with an embodiment of the present invention.

### DETAILED DESCRIPTION

The present invention provides improved methods and apparatus for scheduling a command to be issued on a bus. The present method may employ the read and write address collision lists and first and second dependency matrices of a conventional system. Further, the present invention may maintain a third dependency matrix indicating dependence of write commands on other write commands. The third dependency matrix may be populated by data output from the write address collision list when indexed by respective write commands. Similarly, the present invention may maintain a fourth dependency matrix indicating dependence of read commands on other read commands. The fourth dependency matrix may be populated by data output from the read address collision list when indexed by respective read commands.

Further, in addition to address collision dependencies, the present invention may schedule commands to be issued on a bus based on respective priorities assigned to the commands. A priority assigned to a command may be based on an address associated with the command (e.g., an address targeted by the command). For example, commands associated with addresses within a predetermined range may be of a first, normal priority and commands targeting addresses outside the predetermined range may be of a second, lower priority. The present methods and apparatus may delay lower priority commands from being issued on the bus until normal priority commands are issued on the bus. However, to prevent lower priority commands from being delayed indefinitely, the present methods and apparatus may increase priority of lower priority commands to normal priority after a predetermined time period so that the commands may be issued on the bus. In this manner, the present invention may provide methods and apparatus for scheduling a command to be issued on a bus that may be tailored to system needs.

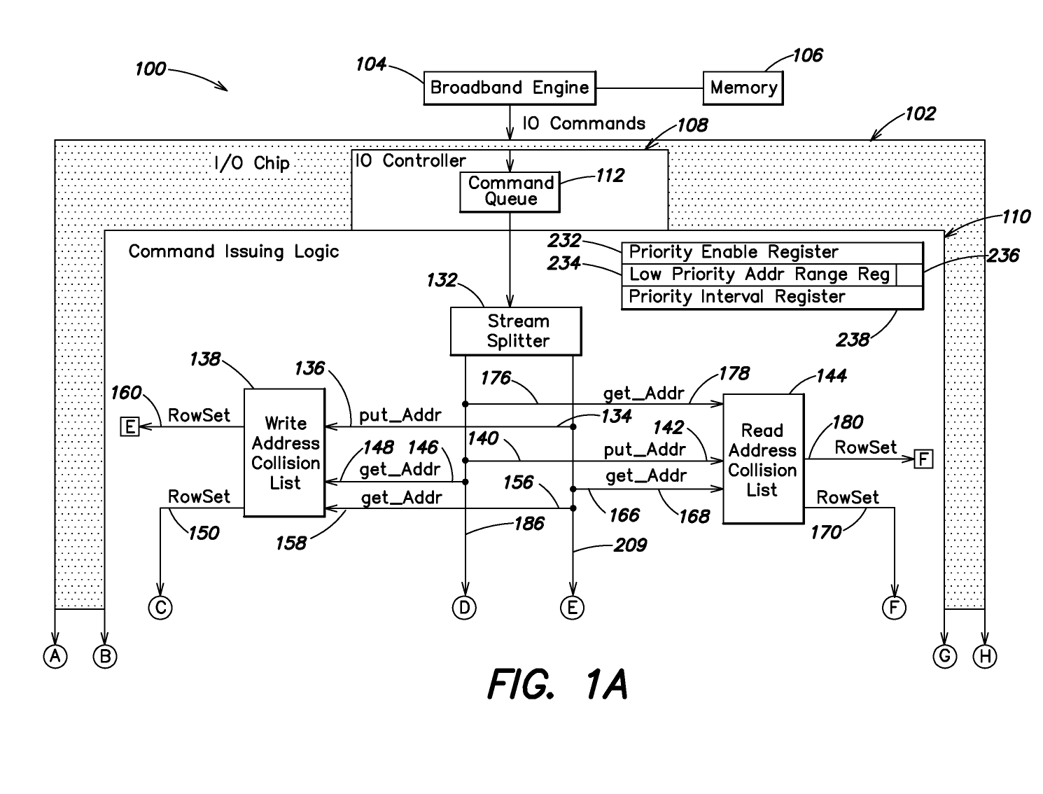

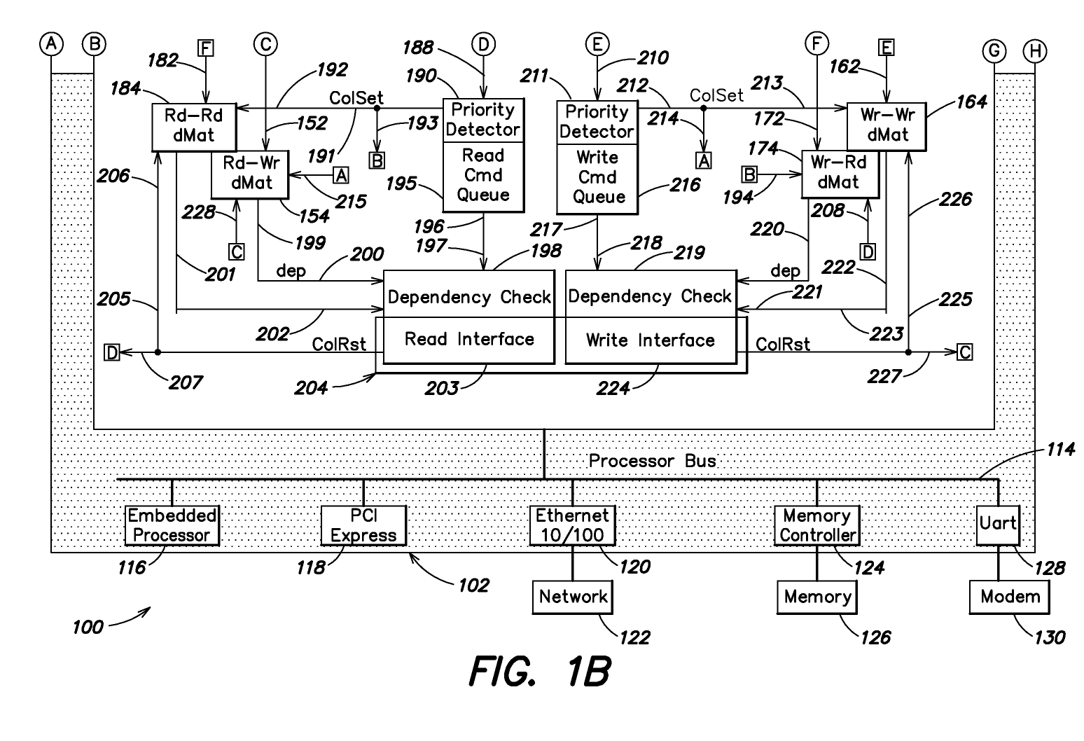

FIGS. 1A-B is a block diagram of a system 100 for scheduling a command to be issued on a bus based on address collision dependencies and a priority of the command in accordance with an embodiment of the present invention. With reference to FIGS. 1A-B, the system 100 may include a first processor 102 coupled to a second processor 104, which may be coupled to a memory 106. The first processor 102 may be adapted to receive commands (e.g., read and/or write commands to an I/O subsystem) from the second processor 104. For example, the first processor 102 may be an input/output (I/O) processor and the second processor 104 may be a main processor or CPU 104 which issues commands to the first processor 102.

The first processor 102 may include an I/O controller 108 coupled to command issuing logic 110 (e.g., bus master logic). The I/O controller 108 may be adapted to receive commands from the second processor 104 and transmit such commands to the command issuing logic 110. More specifically, the I/O controller 108 may include a command queue 112 adapted to store the commands received from the second processor 104 and issue commands therefrom to the command issuing logic 110.

The command issuing logic 110 may be coupled to a processor bus 114. The command issuing logic 110 may be adapted to determine and track address collision dependencies of the commands received thereby. More specifically, the command issuing logic 110 may be adapted to determine whether an address associated with (e.g., targeted by) a received command is the same as an address associated with a previously-received command. Further, the command issuing logic 110 may be adapted to assign priorities to the commands based on whether the address associated with (e.g., targeted by) such commands is within a predetermined address range. The command issuing logic 110 may be adapted to issue commands on the processor bus 114 based on address collision dependencies of and priorities assigned to the commands, respectively. Additional details of the command issuing logic 110 are described below.

The processor bus 114 may be coupled to one or more components and/or I/O device interfaces through which an address associated with a command may be accessed. For example, the processor bus 114 may be coupled to a processor 116 embedded in the first processor 102. Additionally, the processor bus 114 may be coupled to a PCI Express card 118 adapted to couple to a PCI bus (not shown). Further, the processor bus 114 may couple to a network card 120 (e.g., a 10/100 Mbps Ethernet card) through which the first processor 110 may access a network 122, such as a wide area network (WAN) or local area network (LAN). Additionally, the processor bus 114 may couple to a memory controller (e.g., a Double Data Rate (DDR2) memory controller) 124 through which the first processor 110 may couple to a second memory 126. Also, the processor bus 114 may couple to a Universal Asynchronous Receiver Transmitter (UART) 128 through which the first processor 110 may couple to a modem 130. The above connections to the processor bus 114 are exemplary. Therefore, the processor bus 114 may couple to a larger or smaller amount of components or I/O device interfaces. Further, the processor bus 114 may couple to different types of components and/or I/O device interfaces. As described below the command issuing logic 110 may efficiently issue commands on the processor bus 114 which may require access to a component and/or I/O device interface coupled to the processor bus 114.

The command issuing logic 110 may include stream splitter logic 132 adapted to separate commands received by the first processor 102 into a stream of read commands and a stream of write commands. The stream splitter logic 132 may assign respective read tags to received read commands and respective write tags to received write commands.

A first output 134 of the stream splitter logic 132 may be coupled to a first input 136 of the write address collision list 138. The write address collision list 138 may be similar to a contents-addressable memory (CAM) adapted to output data based on input data (e.g., a word). The first input 136 of the write address collision list 138 may be employed to input entries for write commands and respective addresses associated therewith. In this manner, the write address collision list 138 may include entries corresponding to each received write command that is assigned a write tag.

Similarly, a second output 140 of the stream splitter logic 132 may be coupled to a first input 142 of a read address collision list 144. The read address collision list 144 may also be similar to a CAM adapted to output data based on input data. The first input 142 of the read address collision list 144 may be employed to input entries for read commands and respective addresses associated therewith. In this manner, the read address collision list 144 may include entries corresponding to each received read command that is assigned a read tag.

Further, a third output 146 of the stream splitter logic 132 may be coupled to a second input 148 of the write address collision list 138 such that an address associated with a read command may be input by the write address collision list 138. Based on such input, the write address collision list 138 may output one or more bits via a first output 150 thereof, which may be coupled to a first input 152 of a read-write dependency matrix 154. In this manner, the bits may be stored as a row in the read-write dependency matrix 154 (e.g., in response to a row set command by the command issuing logic 110).

A fourth output 156 of the stream splitter logic 132 may be coupled to a third input 158 of the write address collision list 138 such that an address associated with a write command may be input by the write address collision list 138. Based on such input, the write address collision list 138 may output one or more bits via a second output 160 thereof, which may be coupled to a first input 162 of a write-write dependency matrix 164. In this manner, the bits may be stored as a row in the write-write dependency matrix 164 (e.g., in response to a row set command by the command issuing logic 110).

Further, a fifth output 166 of the stream splitter logic 132 may be coupled to a second input 168 of the read address collision list 144 such that an address associated with a write command may be input by the read address collision list 144. Based on such input, the read address collision list 144 may output one or more bits via a first output 170 thereof, which may be coupled to a first input 172 of a write-read dependency matrix 174. In this manner, the bits may be stored as a row in the write-read dependency matrix 174 (e.g., in response to a row set command by the command issuing logic 110).

A sixth output 176 of the stream splitter logic 132 may be coupled to a third input 178 of the read address collision list 144 such that an address associated with a read command may be input by the read address collision list 144. Based on such input, the read address collision list 144 may output one or more bits via a second output 180, which may be coupled to a first input 182 of a read-read dependency matrix 184. In this manner, the bits may be stored as a row in the read-read dependency matrix 184 (e.g., in response to a row set command by the command issuing logic 110).

Additionally, a seventh output 186 of the stream splitter logic 132 may be coupled to an input 188 of first priority detector logic 190 adapted to adjust dependency of read commands (e.g., via a column set command) in the read-read dependency matrix 184 and/or write-read dependency matrix 174 based on a priority associated with a received read command. A first output 191 of the first priority detector logic 190 may be coupled to a second input 192 of the read-read dependency matrix 184. The column set command may be output from the first priority detector logic 190 and input by the read-read dependency matrix 184. Similarly, a second output 193 of the first priority detector logic 190 may be coupled to a second input 194 of the write-read dependency matrix 174. The column set command may be output from the first priority detector logic 190 and input by the write-read dependency matrix 174. Further, the first priority detector logic 190 may be coupled to a queue 195 adapted to store the read commands.

Similarly, an eighth output 209 of the stream splitter logic 132 may be coupled to an input 210 of second priority detector logic 211 adapted to adjust dependency of write commands (e.g., via a column set command) in the write-write dependency matrix 164 and/or read-write dependency matrix 154 based on a priority associated with a received write command. A first output 212 of the second priority detector logic 211 may be coupled to a second input 213 of the write-write dependency matrix 164. The column set command may be output from the second priority detector logic 211 and input by the write-write dependency matrix 164. Similarly, a second output 214 of the second priority detector logic 211 may be coupled to a second input 215 of the read-write dependency matrix 154. The column set command may be output from the priority detector logic 211 and input by the read-write dependency matrix 154. Further, the second priority detector logic 211 may be coupled to a queue 216 adapted to store the write commands.

An output 217 of the write command queue 216 may be coupled to a first input 218 of second dependency check logic 219. Further, a first output 220 of the write-read matrix 174 may be coupled to a second input 221 of the second dependency check logic 219. Similarly, a first output 222 of the write-write dependency matrix 164 may be coupled to a third input 223 of the second dependency check logic 219. The second dependency check logic 219 may be adapted to determine whether dependencies associated with a received write command have cleared. More specifically, the second dependency check logic 219 may receive (e.g., via the second input 221 thereof) one or more bits of information indicating dependence of one or more write commands on read commands from the write-read dependency matrix 174 output from the first output 220 thereof. Further, the second dependency check logic 219 may receive (e.g., via the third input 223 thereof) one or more bits of information indicating dependence of one or more write commands on other write commands from the write-write dependency matrix 164 output from the first output 222 thereof. Based on such bits, the second dependency check logic 219 may determine whether dependencies associated with respective commands in the write queue have cleared.

An output 196 of the read command queue 195 may be coupled to a first input 197 of first dependency check logic 198. Further, a first output 199 of the read-write dependency matrix 154 may be coupled to a second input 200 of the first dependency check logic 198. Similarly, a first output 201 of the read-read dependency matrix 184 may be coupled to a third input 202 of the first dependency check logic 198. The first dependency check logic 198 may be adapted to determine whether dependencies associated with a received read command have cleared. More specifically, the first dependency check logic 198 may receive (e.g., via the second input 200 thereof) one or more bits of information indicating dependence of one or more read commands on write commands from the read-write dependency matrix 154 output from the first output 199 thereof. Further, the first dependency check logic 198 may receive (e.g., via the second input 202 thereof) one or more bits of information indicating dependence of one or more read commands on other read commands from the read-read dependency matrix 184 output from the first output 201 thereof. Based on such bits, the first dependency check logic 198 may determine whether dependencies associated with respective commands in the read queue have cleared.

The first dependency check logic 198 may be coupled to a read interface 203 which forms a first portion of a bus interface 204 through which commands are issued to the bus 114. Once a command that is not dependent on other commands is selected from the read command queue 195, such command may be provided to the read interface 203. When the read command completes on the bus, the read interface 203 may update the read-read and write-read matrices 184, 174 to update dependence of commands stored therein on the selected read command (e.g., via a column reset command). For example, the column reset command may be output from the read interface 203 via a first output 205 thereof and input by a second input 206 of the read-read matrix 184. Similarly, the column reset command may be output from the read interface 203 via a second output 207 thereof and input by a second input 208 of the write-read matrix 174.

The second dependency check logic 219 may be coupled to a write interface 224 which forms a second portion of the bus interface 204. Once a command that is not dependent on other commands is selected from the write command queue 216, such command may be provided to the write interface 224. The write interface 224 may update the write-write and read-write matrices 164, 154 to update dependence of commands stored therein on the selected write command (e.g., via a column reset command). For example, the column reset command may be output from the write interface 224 via a first output 225 thereof and input by a third input 226 of the write-write matrix 164. Similarly, the column reset command may be output from the write interface 224 via a second output 227 thereof and input by a second input 228 of the read-write matrix 154.

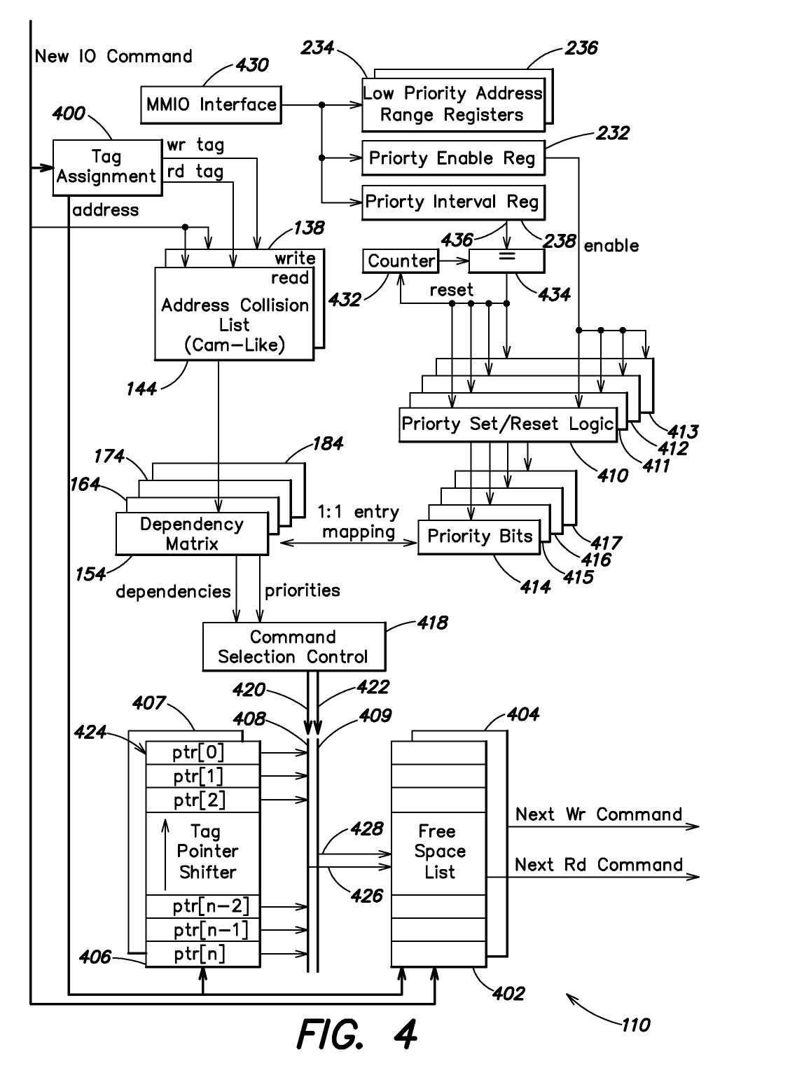

The priorities assigned to respective commands may be based on values stored in a plurality of registers. For example, the command issuing logic 110 may include a first register 232 (e.g., a priority enable register) adapted to define a value which indicates whether the first processing is issuing commands on the processor bus 114 based on priority. Further, the command issuing logic 110 may include second and third registers (e.g., low priority address range registers) 234, 236 adapted to define an address range. Commands associated with an address in such range may be assigned a lower priority (e.g., a low pending priority) than commands stored outside the address range (e.g., normal priority). Additionally, the command issuing logic 110 may include a fourth register 238 (e.g., a priority interval register) adapted to store a value that serves to define an interval after which priority of commands may be updated. For example, the value may be employed by a counter (432 in FIG. 4) of the command issuing logic 102. After the counter counts from 0 to the interval or from the interval to 0, priorities of lower priority commands may be updated to a higher priority, respectively.

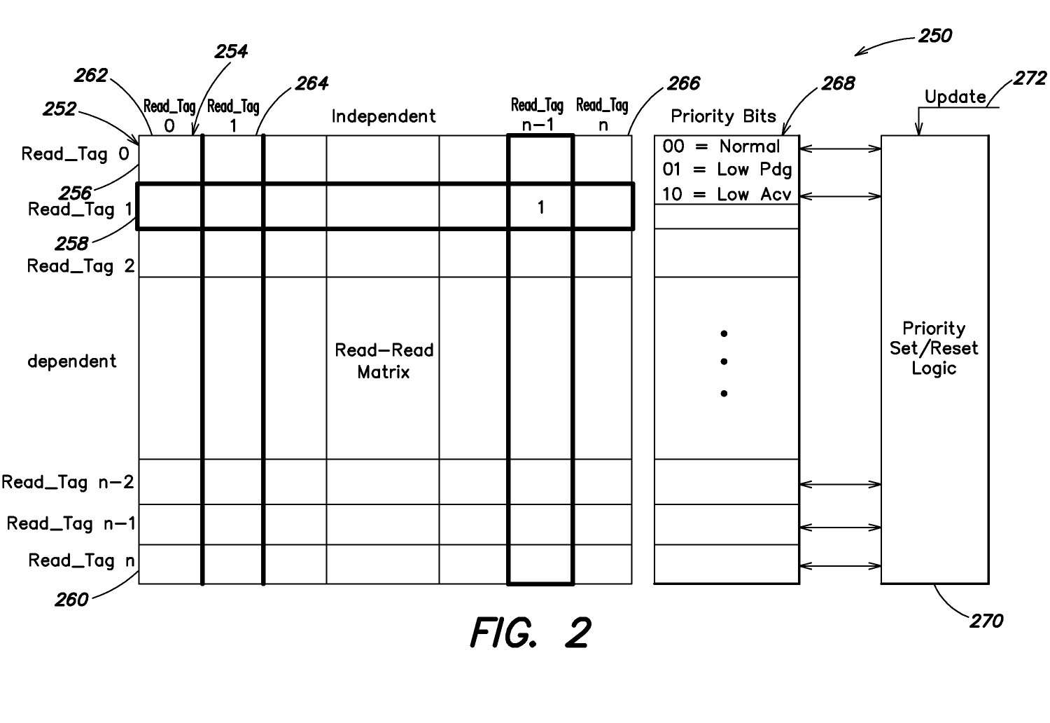

FIG. 2 illustrates an exemplary dependency matrix 250 of the system 100 of FIGS. 1A-B in accordance with an embodiment of the present invention. With reference to FIG. 2, the exemplary dependency matrix 250 may be the read-read dependency matrix (184 in FIGS. 1A-B) of the system 100. The dependency matrix 250 may be arranged into rows 252 and columns 254. Rows 252 of the dependency matrix 250 may correspond to read tags that may be assigned to a command in the command issuing logic 100. For example, assuming the command issuing logic 110 may assign n tags to read commands, a first row 256 of the dependency matrix 250 may correspond to the command assigned Read_Tag 0, a second row 258 of the dependency matrix 250 may correspond to the command assigned Read_Tag 1, and so on, such that the (n−1)th row 260 of the dependency matrix 250 may be assigned Read_Tag n.

Similarly, columns 254 of the dependency matrix 250 may correspond to read tags the may be assigned to commands in the command issuing logic 100. For example, a first column 262 of the dependency matrix 250 may correspond to the command assigned Read_Tag 0, a second column 264 of the dependency matrix 250 may correspond to the command assigned Read_Tag 1, and so on, such that the (n−1)th column 266 of the dependency matrix 250 may be assigned Read_Tag n. The rows 252 may represent dependent values and the columns 254 may represent independent values. In this manner, bits stored in a row corresponding to a read tag assigned to a command may indicate that command's dependence on one or more commands assigned other read tags (e.g., on one or more columns). For example, the asserted bit (e.g., logic “1”) in the second row 258 indicates the command assigned Read_Tag 1 depends on the command assigned Read_Tag n−1. Therefore, the command assigned Read_Tag 1 may not be issued on the bus (114 in FIGS. 1A-B) until the command assigned Read_Tag n−1 is issued on the processor bus 114 and completes. Remaining dependency matrices (154, 164, 174 in FIGS. 1A-B) of the system 100 may be arranged into rows and columns in a similar manner. Therefore, for the read-write dependency matrix 154, rows 252 correspond to read tags and columns 254 correspond to write tags.

One or more priority bits 268 may be associated with each row 252 of the dependency matrix 250. Priority bits of a row 252 may indicate priority assigned to a command associated with the read tag corresponding to such row 252. For example, priority bits state “00” may indicate a command associated therewith is of a Normal priority, priority bits state “10” may indicate a command associated therewith is of a “Low Active” priority which is lower than Normal priority, and priority bits state “01” may indicate a command associated therewith is of a “Low Pending” priority which is lower than Low Active priority. Remaining priority bits state “11” may be undefined (although such state may represent another priority level). Only commands of Normal priority, which are not dependent on other commands in the dependency matrix 250 may be issued on the processor bus 114. Further, the dependency matrix 250 may include and/or be coupled to priority set/reset logic 270 which may be adapted to update priorities associated with the commands corresponding entries of the dependency matrix 250. For example, the priority set/reset logic 270 may include a first input 272 on which signal Update may be received and input into the priority set/reset logic 270. When the priority set/reset logic 270 receives signal Update, the priority set/reset logic 270 may update the one or more priority bits corresponding to each row 252 of the dependency matrix 250. Priority bits corresponding to a row 252 may be updated such that priority bits indicating a “Low Pending” priority may be changed to priority bits indicating a “Low Active” priority. Further, priority bits corresponding to a row 252 may be updated such that priority bits indicating “Low Active” priority may be changed to priority bits indicating a “Normal” priority. Based on such priority bits, the command issuing logic 102 may update columns 254 of the dependency matrix 250 to create dummy address collision dependencies. The dummy dependencies are actually based whether an address associated with a new command is within the address range defined by the low priority address range registers 234, 236. If not, the new command is of Normal priority. A dummy address collision dependency may be created for all commands in the dependency matrix 250 of a lower priority.

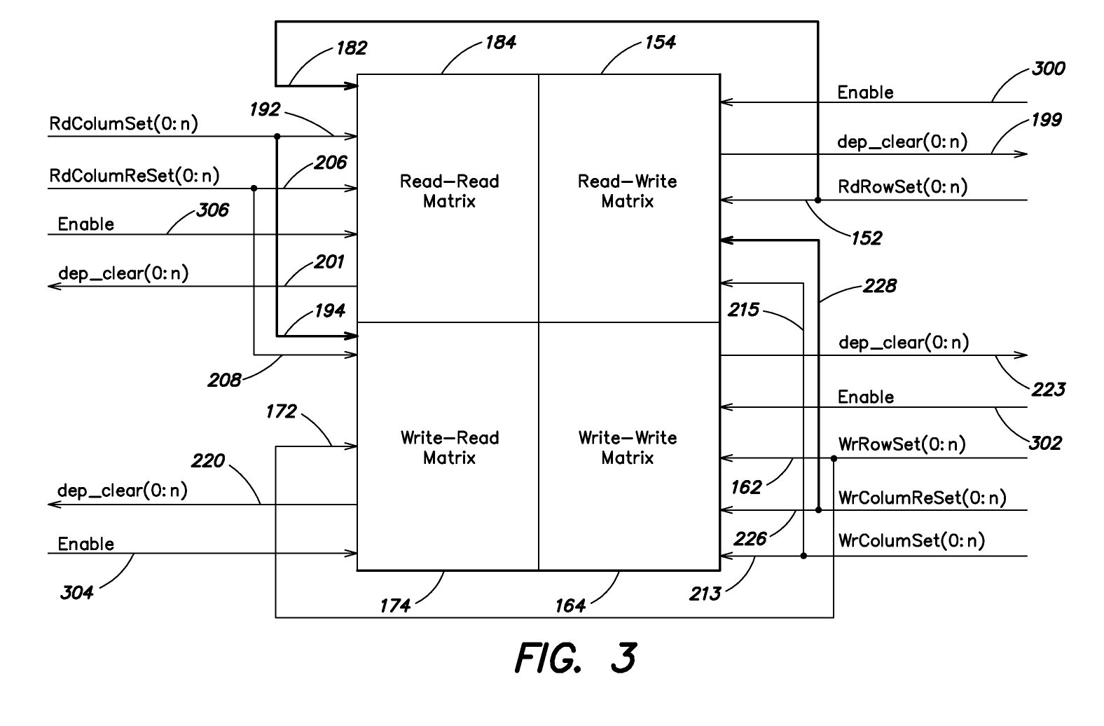

FIG. 3 illustrates dependency matrices 154, 164, 174, 184 of the system 100 of FIGS. 1A-B and signals employed thereby in accordance with an embodiment of the present invention. With reference to FIG. 3, details of signals input by and output from the dependency matrices 154, 164, 174, 184 of the system 100 are illustrated. For example, data may be stored in a row 252 of the read-write matrix 154 by a read row set command RdRowSet(0:n) input by the first input 152 of the matrix 154. In this manner, the read-write matrix 154 may be updated to include information about read commands that depend on write commands because they are associated with the same address (e.g., address collision dependency information). Such data may be output from the write address collision list 138 in response to a lookup. Dependencies of read commands on a write command may be updated in the read-write matrix 154 by a write column set command WrColumSet(0:n) input by the second input 215 of the matrix 154. For example, when a write command of a Normal priority is received, the command issuing logic 110 may employ the write column set command to update dependencies of the read commands stored by the matrix 154 which are of a lower priority. In this manner, a dummy address collision dependency may be set for such read commands based on respective priorities associated therewith on the Normal priority write command. Dependencies of read commands on a write command which has completed may be updated in the read-write matrix 154 by a write column reset WrColumReSet(0:n) input by the second input 228 of the matrix 154. In this manner, when a write command completes, read commands which have a dependency on the write command are updated so the read commands no longer depend therefrom. The read-write matrix 154 may include another input 300 on which a signal Enable may be received. Signal Enable may indicate whether the command issuing logic 110 associates priorities with commands, respectively, and issues commands on the processor bus 114 based on such priorities. The read-write matrix 154 may output data dep_clear(0:n) about dependency of read commands on write commands via the first output 199. Such data may be provided to the second dependency check logic 219, which may select a write command to be issued on the processor bus 114 based on the data.

Similarly, data may be stored in a row 252 of the write-write matrix 164 by a write row set command WrRowSet(0:n) input by the first input 162 of the matrix 164. In this manner, the write-write matrix 164 may be updated to include information about write commands that depend on write commands because they are associated with the same address (e.g., address collision dependency information). Such data may be output from the write address collision list 138 in response to a lookup. Dependencies of write commands on a write command may be updated in the write-write matrix 164 by a write column set command WrColumSet(0:n) input by the second input 213 of the matrix 164. For example, when a new write command of a Normal priority is received, the command issuing logic 110 may employ the write column set command to update dependencies of the write commands stored by the matrix 164 which are of a lower priority. In this manner, a dummy address collision dependency may be set for such write commands based on respective priorities associated therewith on the Normal priority write command. Dependencies of write commands on a write command which has completed may be updated in the write-write matrix 164 by a write column reset command WrColumReSet(0:n) input by the third input 226 of the matrix 164. In this manner, when a write command completes, write commands which have a dependency on the completing write command are updated such that the write commands no longer depend therefrom. The write-write dependency matrix 164 may include another input 302 on which the signal Enable, which indicates whether priorities are assigned to commands, may be received. The write-write dependency matrix 164 may output data dep_clear(0:n) about dependency of write commands on other write commands via the first output 223. Such data may be provided to the second dependency check logic 219, which may select a write command to be issued on the processor bus 114 based on the data.

Similarly, data may be stored in a row 252 of the write-read dependency matrix 174 by a write row set command WrRowSet(0:n) input by the first input 172 of the matrix 174. In this manner, the write-read dependency matrix 174 may be updated to include information about write commands that depend on read commands because they are associated with the same address (e.g., address collision dependency information). Such data may be output from the read address collision list 144 in response to a lookup. Dependencies of write commands on a read command may be updated in the write-read matrix 174 by a read column set command RdColumSet(0:n) input by the second input 194 of the matrix 174. For example, when a read command of a Normal priority is received, the command issuing logic 110 may employ the read column set command to update dependencies of the write commands stored by the matrix 174 which are of a lower priority. In this manner, a dummy address collision dependency may be set for such write commands based on respective priorities associated therewith on the Normal priority read command. Dependencies of write commands on a read command which completes may be updated in the write-read dependency matrix 174 by a read column reset command RdColumReSet(0:n) input by the third input 208 of the matrix 174. In this manner, when a read command completes, write commands which have a dependency on the read command are updated so the write commands no longer depend therefrom. The write-read dependency matrix 174 may include another input 304 on which the signal Enable may be received. Signal Enable may indicate whether the command issuing logic 110 associates priorities with commands, respectively, and issues commands on the processor bus 114 based on such priorities. The write-read dependency matrix 174 may output data dep_clear(0:n) about dependency of write commands on read commands via the first output 220. Such data may be provided to the second dependency check logic 219, which may select a write command to be issued on the processor bus 114 based on the data.

Similarly, data may be stored in a row 252 of the read-read dependency matrix 184 by a read row set command RdRowSet(0:n) input by the first input 182 of the matrix 184. In this manner, the read-read dependency matrix 184 may be updated to include information about read commands that depend on other read commands because they are associated with the same address (e.g., address collision dependency information). Such data may be output from the read address collision list 144 in response to a lookup. Dependencies of read commands on a new read command may be updated in the read-read dependency matrix 184 by a read column set command RdColumSet(0:n) input by the second input 192 of the matrix 184. For example, when a read command of a Normal priority is received, the command issuing logic 110 may employ the read column set command to update dependencies of the read commands stored by the matrix 184 which are of a lower priority. In this manner, a dummy address collision dependency may be set for such read commands based on respective priorities associated therewith on the Normal priority read command. Dependencies of read commands on a read command which completes may be updated in the read-read dependency matrix 184 by a read column reset command RdColumReSet(0:n) input by the third input 206 of the matrix 184. In this manner, when a read command completes, read commands which have a dependency on the completing read command are updated such that the read commands no longer depend therefrom. The read-read matrix 184 may include another input 306 on which the signal Enable may be received. The read-read matrix 184 may output data dep_clear(0:n) about dependency of read commands on read commands via the first output 201. Such data may be provided to the first dependency check logic 198, which may select a read command to be issued on the processor bus 114 based on the data.

Each dependency matrix 154, 164, 174, 184 may be associated with a set of priority bits 268 and priority set/reset logic 270. However, for convenience, such priority bits 268 and priority set/reset logic are not shown in FIG. 3.

FIG. 4 illustrates details of command issuing logic 110 included in the system 100 of FIGS. 1A-B in accordance with an embodiment of the present invention. With reference to FIG. 4, the command issuing logic 110 may receive a new I/O command associated with an address. Tag assignment logic 400, which may be included in and/or coupled to the stream splitter logic 132, may receive the new command. The tag assignment logic 400 may be adapted to associate a read tag with each read command and a write tag with each write command received by the tag assignment logic 400.

The command issuing logic 110 may include command buffers 402, 404 adapted to store read and write commands received by the logic 110, respectively. If the command issuing logic 110 may associate n read tags with read commands and n write tags with write commands, the command buffers 402, 404 may each include n entries (although a larger or smaller number of entries may be employed). Additionally, for each command buffer 402, 404, the command issuing logic 110 may include a queue (e.g., first in, first out (FIFO)) of pointers 406, 407 coupled thereto. The queue of pointers 406, 407 may be adapted to track the structure of the command buffer (e.g., a first and last entry thereof). The queue of pointers may employ a tag pointer shifter to maintain command order for those commands that have ordering requirements and to manage the command buffer with a list of free spaces. The read queue of pointers 406 may be coupled to the read command buffer 402 via a first multiplexer 408 and the write queue of pointers 407 may be coupled to the read command buffer 404 via a second multiplexer 409. Each new command and tag associated therewith may be provided to the corresponding command buffer 402, 404 and/or queue of pointers 406, 407 so such command may be stored in the command buffer 402, 404.

As shown, each new command associated with an address along with a tag associated with the command may be provided to the read address collision list 144 and write address collision list 138. In this manner, the read address collision list 144 may be updated with newly-received read commands and addresses associated therewith, and the write address collision list 138 may be updated with newly-received write commands and addresses associated therewith as described above with reference to FIGS. 1A-B. Further, a read address collision list lookup and write address collision list lookup may be performed for each new command associated with an address and a tag. In this manner, the dependency matrices 154, 164, 174, 184 may be populated as described above with reference to FIGS. 1A-B.

As stated, the command issuing logic 110 may include priority set/reset logic 410, 411, 412, 413 and store priority bits 414, 415, 416, 417 for each dependency matrix 154, 164, 174, 184, respectively, such that there is a 1:1 mapping between priority bits and dependency matrix entries. The priority set/reset logic 410, 411, 412, 413 may be employed to set priority bits 414, 415, 416, 417 associated with a new command that is stored in one or more of the dependency matrices 154, 164, 174, 184.

Further, the dependency matrices 154, 164, 174, 184 may be coupled to command selection control logic 418, which may be included in and/or coupled to the dependency check logic 198, 219. The command selection control logic 418 may receive data about dependencies of a read command on write commands and other read commands. Further, the command selection control logic 418 may receive data about dependencies of a write command on read commands and other write commands. Additionally, the command selection control logic 418 may receive data about priorities associated with one or more entries from one or more of the dependency matrices 154, 164, 174, 184. A first output 420 of the command selection control logic 418 may be coupled to first multiplexer 410 and a second output 422 of the command selection control logic 418 may be coupled to the second multiplexer 409. Based on the dependency and priority data, the command selection control logic 418 may output a signal that serves as a control signal for the first or second multiplexer 408, 409, which determines a pointer 424 from the queue of pointers 406, 407 that may be output from the multiplexer 408, 409 via an output 426, 428 thereof. The pointer 424 output from the multiplexer 408, 409 may serve as the head pointer of the command buffer 402, 404 which identifies the next read or write command to be output from the command buffer 402, 404 onto the bus (114 in FIGS. 1A-B).

The command issuing logic 110 may include a memory-mapped input/output (MMIO) interface 430 coupled to the priority enable register 232, the low priority address range registers 234, 236 and the priority interval register 238. The MMIO interface 430 may be employed by a processor (e.g., the I/O processor 102) to set values stored in such registers 232, 234, 236, 238. The value stored in the priority enable register 232 may serve as signal Enable which indicates whether the first processor 102 issues commands on the processor bus 114 based on respective priorities assigned to the commands. Signal Enable may be coupled to the dependency matrices 154, 164, 174, 184 via the priority set/reset logic 410, 411, 412, 413, in some embodiments, signal Enable may be coupled directly to the dependency matrices 154, 164, 174, 184.

The command issuing logic 110 may include a counter (e.g., priority interval counter) 432 coupled to compare logic 434. Further, the compare logic 434 may be coupled to an output 436 of the priority interval register 238. The counter 432 may be adapted to count up from 0. The compare logic 434 may be adapted to determine when the value of the counter 432 (e.g., after starting from 0) is equal to the value stored by the priority interval register 238. If the compare logic 434 determines the counter value is equal to the priority interval register value, the command issuing logic 110 may reset the counter value. Further, when the compare logic 434 determines the counter value is equal to the priority interval register value, the priority set/reset logic 410, 411, 412, 413 may update respective priorities associated with commands stored in the dependency matrices 154, 164, 174, 184 by updating priority bits associated with the commands stored in the matrices 154, 164, 174, 184. For example, the priority set/reset logic 410, 411, 412, 413 may change all commands of priority “Low Pending” to priority “Low Active”, and may change all commands of priority “Low Active” to “Normal” priority. In this manner, a command may be delayed nearly two times the interval before being assigned the Normal priority so that the command may be issued from the bus. Although the counter 432 counts up, in some embodiments, the counter 432 may be adapted to count down from the priority interval register value to 0.

Exemplary operation of the system 100 for issuing a command on a processor bus 114 is now described with reference to FIGS. 1-4. The first processor 102 may receive one or more commands (e.g., I/O commands) from the second processor 104. Each command may be associated with (e.g., target or require access to) an address. Each command may be received in the I/O controller 108 and stored in the command queue 112. From the command queue 112, the command may be provided to the stream splitter logic 132. If the new command is a read command, the stream splitter logic 132 may channel the command to the read command queue 195. Alternatively, if the new command is a write command, the stream splitter logic 132 may channel the command to the write command queue 216. The stream splitter logic 132 may assign a tag to the new command based on tag availability. The stream splitter logic 132 may employ zero priority to assign a tag to the command. For example, assume the new command is a read command and the command issuing logic 110 employs sixteen read tags Read_Tag 0-Read_Tag 15. If Read_Tag 0 and Read_Tag 1 are used and remaining read tags are free, the stream splitter logic 132 may assign the Read_Tag 2 to the new read command. However, the stream splitter logic 132 may assign tags in a different manner.

The command issuing logic 110 may determine whether the new command targets the same address as one or more previously-received command, and therefore, depends thereon. For example, the address associated with the new command may be employed to index the address collision lists 138, 144. In response, each of the read and write address collision lists 138, 144 may output data indicating previously-received commands which target the same address as the new command (e.g., address collision dependency data). The command issuing logic 110 may employ an arbitrary byte boundary for addresses associated with commands (although full addresses may be employed). For example, a 256-Byte boundary may be employed for such addresses. Therefore, the address collision lists 138, 144 may be indexed on a 256-Byte boundary.

Further, the command issuing logic 110 may be adapted to compare the address associated with new command with addresses stored in the low priority address range registers 234, 236. If the address is in the low priority address range defined by the registers 234, 236, the command issuing logic 110 may assign a “Low Pending” priority to the command. Otherwise, the command issuing logic 110 may assign a “Normal” priority to the command.

The address collision dependency data and priority data related to the new command may be stored in one or more of the dependency matrices 154, 164, 174, 184. For example, address collision dependency data and priority data related to the new read command may be stored in the read-read and read-write dependency matrices 184, 154. Similarly, if the new command is a write command, address collision dependency data and priority data related to the command may be stored in the write-write and write-read matrices 164, 174. An entry for the new command may be placed in such dependency matrices 154, 164, 174, 184 in a row 252 corresponding to the tag assigned to the command. Assuming again that the new read command is assigned Read_Tag 2, the address collision dependency data and priority data related to the new read command may be stored in the third row of each of the read-read and read-write dependency matrices 184, 154.

The new command may be provided to the corresponding address collision dependency list 138, 144 to update such list 138, 144. For example, the new read command may be provided to the read address collision list 144 so that an entry corresponding to the new read command may be added to the list 144. The entry may include the read command and an address associated therewith, and may be indexed by the assigned tag. If the new command is a write command, the write address collision dependency list 138 may be updated in a similar manner.

The new command may be transmitted from the stream splitter logic 132 to the associated queue via a corresponding priority detector logic 190, 211. For example, the new read command may be transmitted from the stream splitter logic 132 to the read command queue 195 via the first priority detector logic 190. If the address associated with the new command is of “Normal” priority, the priority detector logic 190, 211 may write data to a column corresponding to the tag assigned to the new command (e.g., via a Column Set command) for one or more dependency matrices 154, 164, 174, 184. Such a column write to the dependency matrix 154, 164, 174, 184 indexed by the tag assigned to the new command may set a create a dependency on the new command for all lower priority commands (e.g., “Low Pending” and “Low Active” priority commands) with valid tags (if not already set). In this manner, a dummy address collision dependency on the new command may be created for previously-received commands based on respective priorities assigned to the commands. If the new command is a Normal priority read command, the first priority detector logic 190 may write a column 254 in the read-read matrix 184 and write-read matrix 174. Alternatively, if the new command is a Normal priority write command, the second priority detector logic 211 may write a column 254 in the write-write matrix 164 and read-write matrix 154. Thus, the command issuing logic 110 may create forward and reverse cross-dependencies for a command (e.g., the command may have a dependency of previously-received and subsequently received commands).

The first processor 102 may continue to receive commands (e.g., from the second processor 104). When the value of the priority interval counter 432 reaches the priority interval register value, the command issuing logic 110 may update (e.g., via the priority set/reset logic 270) all priorities assigned to commands stored in the dependency matrices 154, 164, 174, 184. For example, the priority set/reset logic 270 may change commands having priority “Low Pending” to priority “Low Active” and may change commands having priority “Low Active” to priority “Normal”. Priority bits 414, 415, 416, 417 associated with commands may be updated to change the priorities of the commands. In this manner, when priorities are enabled and the value of the priority counter 432 matches the value of the priority interval register 238, all valid Low Active priority bits in each dependency matrix 154, 164, 174, 184 are switched from a Low Active priority to a Normal Priority. However, no change may be made to the address collision dependencies or dummy address collision dependencies, which are based on priority, at this time. Rather, the address collision dependencies and/or dummy address collision dependencies may be cleared, via the Column Reset command, when an independent command which caused such dependencies completes (e.g., completes after being issued on the processor bus 114 via its respective interface 203, 224). In this manner, dependencies may clear normally before a command can be issued on the processor bus 114.

The dependency check logic 198, 219 may receive address collision dependency and priority data related to the commands stored in the dependency matrices 154, 164, 174, 184 and determine whether address collision dependencies and dummy address collision dependencies have cleared. When all address collision dependencies and dummy address collision dependencies of a command stored in a queue 195, 216 clear, the command may be issued on the processor bus 114 via its associated interface 203, 224 based on whether command priorities are enabled (e.g., based on the value stored in the priority enable register 232). For example, if command priorities are enabled, the command issuing logic 110 may issue a command on the processor bus 114 from the command queues 195, 216 (e.g., command buffers 402, 404) out of order based on priority. The command selection control logic 418 may be employed to select a pointer 424 from the queue of pointers 406, 407 which serves as a head pointer of the command buffer 402, 404 from which a command is selected to be issued on the processor bus 114. If there are no low priority (e.g., Low Active and/or Low Pending) commands in the queues 195, 216, the command issuing logic 110 may issue commands from such queues 195, 216 in FIFO order, as dependencies clear. Alternatively, if command priorities are not enabled, commands may be issued on the processor bus 114 from a command queue 195, 216 in FIFO order (e.g., independent of priority level).

Details of a read command received and processed by the first processor 102 are described above. However, a write command may be received and processed in a similar manner.

Through use of the present methods and apparatus, address collision dependencies of commands along with respective priorities of the commands may be employed to tailor issuance of commands on a processor bus 114 to needs of a system 100. For example, commands to be issued on the processor bus 114 may be stalled based on priority levels and address collision dependencies associated with the commands. More specifically, the present methods and apparatus may employ dependency logic such as conventional address collision lists and conventional dependency matrices modified to store and update priority bits along with other logic to assign a normal or lower priority to received commands, to create address collision dependencies for commands, and to create dummy address collision dependencies for lower priority commands when a new normal priority command is received. The methods and apparatus may employ MMIOable registers 232-238 within the command issuing logic 110 to store address ranges which define the lower priority commands. Further, the present methods and apparatus may increase priority of lower priority commands after a predetermined number of cycles regardless of whether Normal priority commands are present. In this manner, a maximum number of cycles the lower priority command may be held off in the presence of higher priority traffic may be defined, and therefore the lower priority command is not delayed indefinitely. Therefore, the present methods and apparatus may prioritize I/O commands by forcing dependencies based on whether addresses associated with the commands are within a predetermined range and based on a predetermined time interval. To wit, the present methods and apparatus may force dependencies on all members of a group that are prioritized behind members of another group with a revolving priority that expires at the end of each predetermined time period (e.g., priority interval). The predetermined time period may be adjusted as desired, thereby increasing flexibility of the command prioritizing system.

Thus, a user, such as a system designer, may employ the present methods and apparatus, which may be a mechanism within an I/O chip, to prioritize command traffic through the first processor 102 based on system needs. In an exemplary system, primary command traffic from the second processor 104 to the first processor 102 may target addresses related to the network 122 (e.g., LAN or WAN). However, the exemplary system may receive intermittent secondary command traffic related to a modem 130 coupled to UART 128. The system designer may want to prevent the command traffic related to the modem 130 from adversely affecting the command traffic related the network 122. By using the present methods and apparatus, the user may delay issuance of secondary commands on the processor bus 114 when primary commands have to be issued on the processor bus 114. The exemplary system may assign priorities to the command traffic and updated respective priorities assigned to the commands based on a predetermined time interval (e.g., when the predetermined time interval lapses). In this manner, respective priorities associated with the secondary commands may be increased after the predetermined time period, and therefore, such traffic may not be stopped indefinitely even when the primary command traffic volume is high.

Thus, similar to a conventional I/O processor, the present invention provides an I/O processor 102 which may receive read, write, ensure in-order execution of I/O (eieio) and/or similar commands from another processor (e.g., CPU) via an I/O interface. The I/O processor 102 may buffer the commands and master the commands on to a processor bus 114 (e.g., a local processor bus (PLB)) from which the commands may be passed along to an appropriate device (e.g., PCI-express interface card or DDR2 memory controller). To prevent unnecessary stalls of the write commands while waiting for read commands to complete, the I/O processor may split received commands into separate read and write streams. Because commands are separated in this manner, command order should be maintained between the streams. Depending on interfaces involved and command target address, the ordering rules may range from strict to relaxed. Strict ordering states that the read and write commands must complete in the same order that they are issued from the CPU. Relaxed ordering states that read and write commands can pass each other if they are not targeting the same address space. However, another ordering rule may be employed. The ordering rule is passed along with the command as the command flows from the CPU. Ordering between the read and write streams is maintained using a dependency matrix for each stream and an address look-up list to calculate dependencies. As read and write commands reach the top of their respective queue, a dependency check is performed to see if there are any outstanding dependencies. If there are dependencies then the command and its respective queue is stalled until the dependency is cleared.

In contrast to a conventional I/O processor, the present methods and apparatus store dependency of both read and write commands on current in-flight read and/or write commands. Thus, four dependency matrices are employed 154, 164, 174, 184. The dependencies stored in dependency matrices 154, 164, 174, 184 are address collision dependencies. For example, if a read command is followed by a write command that is targeting the same address space, the write command may get a dependency on the read command and may not complete until the read command finishes. In contrast to the conventional I/O processor, the present methods and apparatus may create and assign priorities to the commands. Such priorities may be updated after a predetermined time period. Further, the present methods and apparatus may create dummy address collision dependencies for commands based on such priorities. The priorities and dummy address collision dependencies may be stored in the dependency matrices 154, 164, 174, 184. Based on the address collision dependencies, dummy address collision dependencies and priorities, the present methods and apparatus may provide a customizable and efficient method of scheduling commands to be issued on a bus.

The foregoing description discloses only exemplary embodiments of the invention. Modifications of the above disclosed apparatus and methods which fall within the scope of the invention will be readily apparent to those of ordinary skill in the art. For instance, although the system 100 for prioritizing commands based on respective target addresses by forcing address collision dependencies over a priority interval specified by the system user employs three priority levels (e.g., Low Pending, Low Active and Pending), a larger or smaller number of priority levels may be employed.

Accordingly, while the present invention has been disclosed in connection with exemplary embodiments thereof, it should be understood that other embodiments may fall within the spirit and scope of the invention, as defined by the following claims.

The Invention claimed is:

1. A method of scheduling a command to be issued on a bus, comprising:
associating an address and priority with each of a plurality of commands to be issued on the bus, wherein the priority associated with each command is based on the address associated with the command;
updating the priority associated with each command after a predetermined time period; and
from the plurality of commands, selecting a command to be issued on the bus based on the associated address and updated priority associated with the command to be issued.

2. The method of claim 1 further comprising issuing the selected command on the bus.

3. The method of claim 1 wherein the priority is based on whether the address associated with the command is within a predetermined address range.

4. The method of claim 1 wherein updating the priority associated with the command includes increasing the priority associated with the command.

5. The method of claim 1 further comprising preventing the command from being issued on the bus until the priority level of the command is changed to a higher priority or a subsequently-received command of the higher priority is issued on the bus.

6. The method of claim 1 wherein selecting the command based on the associated address and updated priority includes selecting the command based on whether the address associated with the command is also associated with a previously-received command and whether the updated priority is a predetermined priority.

7. The method of claim 1 wherein selecting the command to be issued on the bus from the plurality of commands includes, when another command associated with the same address completes, selecting the command to be issued on the bus from the plurality of commands based on the updated priority.

8. An apparatus for scheduling a command to be issued on a bus, comprising:
a bus; and
command issuing logic coupled to the bus and adapted to:
associate an address and priority with each of a plurality of commands to be issued on the bus, wherein the priority associated with each command is based on the address associated with the command;
update the priority associated with each command after a predetermined time period; and
from the plurality of commands, select a command to be issued on the bus based on the address and updated priority associated with the command to be issued.

9. The apparatus of claim 8 wherein the command issuing logic is further adapted to issue the selected command on the bus.

10. The apparatus of claim 8 wherein the priority is based on whether the address associated with the command is within a predetermined address range.

11. The apparatus of claim 8 wherein the command issuing logic is further adapted to increase the priority associated with the command.

12. The apparatus of claim 8 wherein the command issuing logic is further adapted to prevent the command from being issued on the bus until the priority level of the command is changed to a higher priority or a subsequently-received command of the higher priority is issued on the bus.

13. The apparatus of claim 8 wherein the command issuing logic is further adapted to select the command based on whether the address associated with the command is also associated with a previously-received command and whether the updated priority is a predetermined priority.

14. The apparatus of claim 8 wherein the command issuing logic is further adapted to, when another command associated with the same address completes, select the command to be issued on the bus from the plurality of commands based on the updated priority.

15. A system for scheduling a command to be issued on a bus, comprising:
a first processor; and
a second processor coupled to the first processor and adapted to receive a plurality of commands from the first processor;
wherein the second processor includes an apparatus for issuing a command on a bus, having:
a bus; and
command issuing logic coupled to the bus and adapted to:
associate an address and priority with each of the plurality of commands to be issued on the bus, wherein the priority associated with each command is based on the address associated with the command;
update the priority associated with each command after a predetermined time period; and
from the plurality of commands, select a command to be issued on the bus based on the address and updated priority associated with the command to be issued.

16. The system of claim 15 wherein the command issuing logic is further adapted to issue the selected command on the bus.

17. The system of claim 15 wherein the priority is based on whether the address associated with the command is within a predetermined address range.

18. The system of claim 15 wherein the command issuing logic is further adapted to increase the priority associated with the command.

19. The system of claim 15 wherein the command issuing logic is further adapted to prevent the command from being issued on the bus until the priority level of the command is changed to a higher priority or a subsequently-received command of the higher priority is issued on the bus.

20. The system of claim 15 wherein the command issuing logic is further adapted to select the command based on whether the address associated with the command is also associated with a previously-received command and whether the updated priority is a predetermined priority.

21. The system of claim 15 wherein the command issuing logic is further adapted to, when another command associated with the same address completes, select the command to be issued on the bus from the plurality of commands based on the updated priority.
